(19) United States
(12) Patent Application Publication
(10) Pub. No.: US 2021/0066949 A1
(43) Pub. Date: Mar. 4, 2021

(54) Mains Power Fixture with Galvanic Isolation

(71) Applicant: Spark Connected LLC, Dallas, TX (US)

(72) Inventors: Petru Emanuel Stingu, Dallas, TX (US); Kenneth Moore, Dallas, TX (US); Ruwanga Dassanayake, Dallas, TX (US); Yulong Hou, Farmers Branch, TX (US)

(21) Appl. No.: 16/552,852

(22) Filed: Aug. 27, 2019

(51) Int. Cl. H02J 7/02; H02J 50/10; H02M 7/04; H02J 7/00; H01H 45/00

(52) U.S. Cl. CPC H02J 7/025; H02J 50/10; H01H 45/00; H02J 7/0052; H02M 7/04

(57) ABSTRACT

In an embodiment, a mains power fixture includes: mains input terminals or wires configured to be coupled to mains power supply; a wireless charging area; a rectifier coupled to the mains input terminals; and a wireless charger directly electrically connected to the rectifier. The wireless charger includes: a ferrite core in proximity to the wireless charging area, a transmitter coil wrapping around the ferrite core, and a driver configured to receive a rectified voltage from the rectifier and to drive the transmitter coil at a switching frequency.

### TECHNICAL FIELD

The present invention relates generally to an electronic system and method, and, in particular embodiments, to mains power fixture with galvanic isolation.

### BACKGROUND

Generally, mains power (also called grid power, wall power or domestic power) is available in buildings across the world. For example, in the U.S., alternating-current (AC) electric power is available at a nominal voltage of 120 V_{RMS} and at a frequency of 60 Hz. In other countries, such as countries in Europe, AC electric power is available at a nominal voltage of 230 V_{RMS} and at a frequency of 50 Hz.

Mains power is generally made available through electrical outlets. For example, FIG. 1 shows conventional electrical outlet 100 available in the U.S. Other countries follow different standards for making mains power available at an electrical outlet. For example, FIGS. 2 and 3 shows conventional electrical outlets 200 and 300, available in Italy and Germany, respectively.

Mains power is sometimes connected directly to lights, or other permanently connected equipment, such as a garbage disposal in a kitchen. Light switches are conventionally used to control the turning on or off of such equipment. For example, FIG. 4 shows conventional light switch 400 having a Decora design.

### SUMMARY

In accordance with an embodiment, a mains power fixture includes: mains input terminals or wires configured to be coupled to mains power supply; a wireless charging area; a rectifier coupled to the mains input terminals; and a wireless charger directly electrically connected to the rectifier. The wireless charger includes: a ferrite core in proximity to the wireless charging area, a transmitter coil wrapping around the ferrite core, and a driver configured to receive a rectified voltage from the rectifier and to drive the transmitter coil at a switching frequency.

In accordance with an embodiment, a light switch includes: mains input terminals configured to be coupled to mains power supply; a wireless charging area; a rectifier coupled to the mains input terminals; a wireless charger coupled to the rectifier; a switch coupled to a first input terminal of the mains input terminals, where the switch is configured to be coupled to a load; and a controller configured to control the switch to turn on and off the load. The wireless charger includes: a ferrite core in contact with the wireless charging area, a transmitter coil wrapping around the ferrite core, and a driver configured to receive a rectified voltage from the rectifier and to drive the transmitter coil at a switching frequency.

In accordance with an embodiment, a method includes: receiving mains power with mains input terminals; rectifying the mains power with a diode bridge to provide a rectified voltage; and driving a transmitter coil at a switching frequency with a driver that receives the rectified voltage to transmit wireless power through a wireless charging area. The transmitter coil is wrapped around a ferrite core that is in contact with the wireless charging area.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1-3 show conventional electrical outlets;

FIG. 4 shows a conventional light switch having a Decora® design;

FIG. 5 shows a wireless charger outlet, according to an embodiment of the present invention;

FIG. 6 shows a mains power fixture, according to an embodiment of the present invention;

FIG. 7 shows the mains power fixture of FIG. 6 wirelessly powering a receiver, according to an embodiment of the present invention;

FIG. 8 shows a perspective view of a transmitter coil of the wireless transmitter of FIG. 7 and a receiver coil of the receiver of FIG. 7, according to an embodiment of the present invention;

FIG. 9 shows a front view of the transmitter coil of FIG. 7 attached to the wireless charging area of FIG. 5, according to an embodiment of the present invention;

FIG. 10 shows a receiver magnetically attached to a mains power fixture, according to an embodiment of the present invention;

FIGS. 11A and 11B show a front view and top view, respectively, of a ferrite core, according to an embodiment of the present invention;

FIG. 12 shows an electrical schematic of a mains power fixture during wireless charging of a receiver, according to an embodiment of the present invention; and

FIG. 13 shows a schematic diagram of a mains power fixture that includes switch functionality, according to an embodiment of the present invention.

Corresponding numerals and symbols in different figures generally refer to corresponding parts unless otherwise indicated. The figures are drawn to clearly illustrate the relevant aspects of the preferred embodiments and are not necessarily drawn to scale.

### DETAILED DESCRIPTION OF ILLUSTRATIVE EMBODIMENTS

The making and using of the embodiments disclosed are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The description below illustrates the various specific details to provide an in-depth understanding of several example embodiments according to the description. The embodiments may be obtained without one or more of the specific details, or with other methods, components, materials and the like. In other cases, known structures, materials or operations are not shown or described in detail so as not to obscure the different aspects of the embodiments. References to “an embodiment” in this description indicate that a particular configuration, structure or feature described in relation to the embodiment is included in at least one embodiment. Consequently, phrases such as “in one embodiment” that may appear at different points of the present description do not necessarily refer exactly to the same embodiment. Furthermore, specific formations, structures or features may be combined in any appropriate manner in one or more embodiments.

Embodiments of the present invention will be described in a specific context, mains power fixtures with galvanic isolation using a wireless charger. Embodiments of the present invention may be used in devices such as wall-mounted virtual assistant terminals, smart (display) thermostats that can be removed from the wall, removable security panels, internet of things (IoT) sensors, such as temperature sensors, light sensors, and humidity sensors. Other devices and applications are also possible.

It is understood that the term wireless charging is not limited to the charging of a battery, but includes wireless power transmission generally, unless stated otherwise.

In an embodiment of the present invention, a mains power fixture that includes a wireless charger and a wireless charger outlet is used to power a device while galvanically isolating the device from mains power and without connecting wires to the device. The wireless charger is inside a surface (e.g., a wall) and receives power from mains. A wireless power outlet is disposed (e.g., flush or substantially flush) at an outer surface of the surface (e.g., at an outer surface of the wall). The wireless charger transmits wireless power through the wireless charger outlet using a transmitter coil that surrounds a ferrite core that is inside the surface (e.g., inside the wall). The wireless charger outlet is compatible with conventional electrical outlets and switches (such as switches having a Decora® design). The device is attached to the wireless power outlet (e.g., magnetically) during wireless charging.

In some embodiments, the mains power fixture is also use as a switch. Such switch is controlled, e.g., by tapping the wireless power outlet (e.g., 1 tap to turn on, two taps to turn off). The mains power fixture is, therefore, advantageously capable to simultaneously provide wireless power to a device and control lights, or other permanently connected equipment.

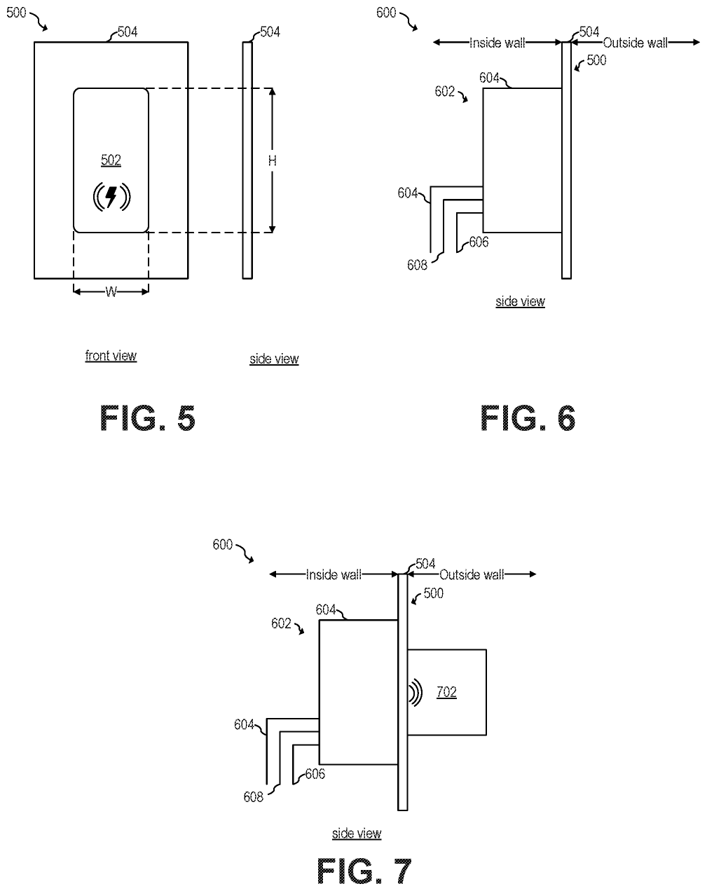

FIG. 5 shows wireless charger outlet 500, according to an embodiment of the present invention. Wireless charger outlet 500 includes cover 504 and wireless charging area 502. Cover 504 and wireless charging area 502 are configured to be electrically isolated from mains.

Cover 504 may be implemented with plastic. Other materials may also be used. In some embodiments, cover 504 may be compatible with covers with a Decora® design and may have a Decora® design.

Wireless charging area 502 is disposed flush with respect to cover 504, as shown in FIG. 5. As a non-limiting example of possible dimensions for wireless charging area 502, width W may be 30 mm and height H may be 65 mm, for example. Other dimensions are also possible.

Wireless charging systems are becoming ubiquitous in today's society. For example, many smartphones and wearables implement wireless charging technology. Ease of use, greater reliability, spatial freedom, reduced connectors and openings, and the possibility of hermetically sealing are among the benefits offered by wireless charging. Wireless charging standards allow for interoperability between different devices and manufacturers. Some wireless charging standards, such as the Qi standard from the Wireless Power Consortium, are becoming widely adopted.

Wireless charging standards, such as the Qi standard, provide specifications that cover various aspects of the wireless charging process, including the frequency used to transmit wireless power from a wireless charger to a receiver, and communication protocols that allow a receiver to communicate with a wireless charger. The standards also provide specifications directed to safety of the wireless charger and the receiver.

FIG. 6 shows mains power fixture 600, according to an embodiment of the present invention. Mains power fixture 600 includes wireless charger 602 and wireless power outlet 500. Wireless charger 602 includes wireless charger enclosure 604 and is coupled to mains power via hot wire 604, neutral wire 608 and ground wire 606.

As shown in FIG. 6, mains power fixture 600 may be implemented inside a wall. In some embodiments, mains power fixture may be implemented below the floor, above the ceiling, or inside a table, for example.

In some embodiments, mains power fixture 600 is compatible with conventional power outlets, such as power outlets with Decora design. In other words, a conventional power outlet may be replaced with mains power fixture 600 without modifying the electrical wiring from mains and without modifying the structure surrounding the conventional power outlet (e.g., without modifying the wall).

FIG. 7 shows mains power fixture 600 wirelessly powering receiver 702, according to an embodiment of the present invention.

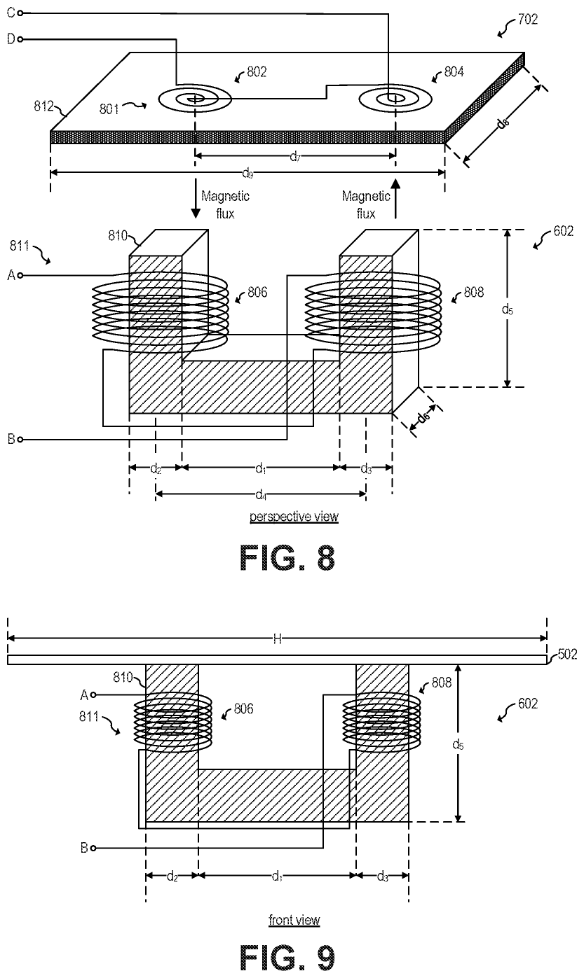

Wireless charger 602 includes a transmitter coil and receiver 702 includes a receiver coil. FIG. 8 shows a perspective view of transmitter coil 811 and receiver coil 801, according to an embodiment of the present invention. Transmitter coil 811 includes first winding 806 and second winding 808 wrapped around ferrite core 810. Receiver coil 8oi includes first winding 802 and second winding 804.

Transmitter coil 811 may be implemented, for example, with Litz wire. Other implementations are also possible.

Receiver coil 8oi may be implemented with traces in a printed circuit board (PCB) for example. Other implementations are also possible.

In some embodiments, receiver 702 may be a portable device, such as a smartphone or wearable watch, for example. In some embodiments, receiver 702 may also be a smart home device, such as a smart thermostat or smart speaker, for example. Receiver 702 may also be implemented as other devices. For example, in some embodiments, receiver 702 may be a wall-mounted virtual assistant terminal, a smart (display) thermostat that can be removed from the wall, a removable security panel, and/or an internet of things (IoT) sensor, such as temperature sensor, light sensor, and/or humidity sensor.

As shown in FIG. 8, ferrite core Bio may have a U shape, where air may be in between each end of the U shaped ferrite core. When transmitter coil 811 is energized, a magnetic field is generated, where the magnetic flux enters from one end of the U-shaped ferrite core Bio and exists in another end of the U-shaped ferrite core 810, as shown in FIG. 8. Other shapes are also possible.

In some embodiments, distance d₇ between centers of windings 802 and 804 is equal or substantially equal (e.g., +/−20%) to distance d₄ between centers of windings 806 and 808. By having distances d₇ and d₄ equal or substantially equal, windings 802 and 804 are capable of aligning with windings 806 and 808, thus, maximizing the coupling coefficient between transmitter coil 811 and receiver coil 801. Maximizing the coupling coefficient between transmitter coil 811 and receiver coil 801 advantageously increases wireless charging efficiency.

In some embodiments, distance d₂ is equal or substantially equal to distance d₃. As a non-limiting example of possible dimensions of receiver coil 811, ferrite core 810 and receiver coil 801 and PCB 812, distance d₁ may be 9 mm, distances d₂ and d₃ may be 8 mm each, distances d₄ and d₇ may be 20 mm each, distance d₅ may be 20 mm, distances d₆ and d₈ may be 12 mm each, and distance d₉ may be 35 mm. Other dimensions are also possible. For example, in some embodiments distances d₄ and d₇ may each range from 10 mm to 30 mm.

FIG. 9 shows a front view of transmitter coil 811 attached to wireless charging area 502, according to an embodiment of the present invention. As shown in FIG. 9, ferrite core 810 is in contact with wireless charging area 502. In some embodiments, ferrite core 810 is proximate but not in contact with wireless charging area 502. For example, in some embodiments, ferrite core 810 has an edge that is within 2 mm of wireless charging area 502 (e.g., via an adhesive, not shown in FIG. 9). Other implementations are also possible.

FIG. 10 shows receiver 702 magnetically attached to mains power fixture 600, according to an embodiment of the present invention. As shown in FIG. 10, mains power fixture 60o may include magnet 1002, and receiver 702 may include magnet 1004. The presence of magnets 1002 and 1004 does not substantially degrade the performance of wireless charging. In some embodiments, the magnets may be placed in other locations, such as near edges of mains power fixture 600. In some embodiments, receiver 702 magnetically may be attached to mains power fixture 600 in other ways, such as using mechanical attachment (e.g., screws, adhesive, etc.).

During normal operation, magnets 1002 and 1004 advantageously keep receiver 702 in contact with wireless charging area 502 without additional structures or cables. During wireless charging, receiver 702 is advantageously galvanically isolated from mains power.

In some embodiments, magnet 1004 is in contact with mains power fixture 600. In some embodiments, magnet 1002 is attached to cover 504.

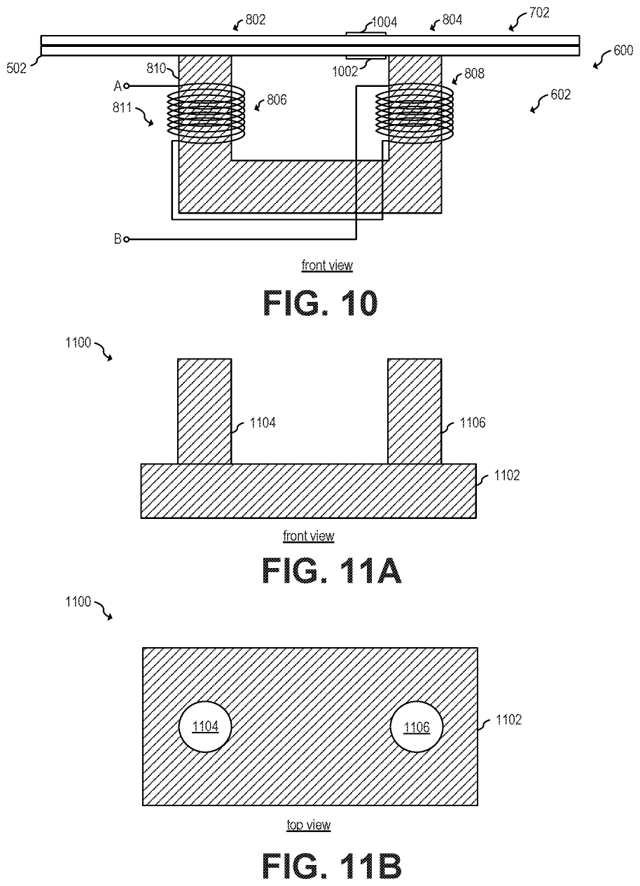

In some embodiments, ferrite core 810 is formed as a single and uniform core, as shown in in FIG. 9. In other embodiments, ferrite core 810 is formed as a plurality of separate ferrite pieces that are attached together (e.g., with adhesive). For example, FIGS. 11A and 11B show a front view and top view, respectively, of ferrite core 1100, according to an embodiment of the present invention.

As shown in FIGS. 11A and 11B, ferrite core 1100 includes ferrite base 1102 and ferrite rods 1104 and 1106. Windings 806 and 808 (not shown), wrap around ferrite rods 1104 and 1106, respectively. Ferrite core 1100 may advantageously have lower cost of manufacturing than a ferrite core formed as single core without substantially affecting the associated magnetic flux.

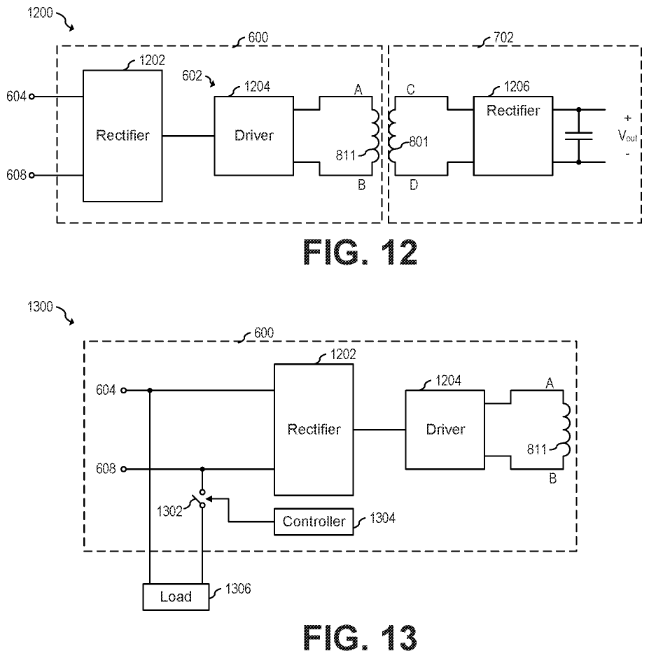

FIG. 12 shows electrical schematic 1200 of mains power fixture 600 during wireless charging of receiver 702, according to an embodiment of the present invention. During normal operation, mains power fixture receives AC power from hot wire 604 and neutral wire 608. Rectifier 1202 rectifies the AC power into DC power. The DC power powers driver 1204, which is configured to drive transmitter coil 811. Current circulating through transmitter coil 811 induces a corresponding current in receiver coil 801, and a voltage across receiver coil 801. Rectifier 1206 rectifies the voltage from receiver coil 801 to generate voltage Vₒᵤₜ, which may be provided to a receiver circuit (not shown).

Receiver 702 receives power from transmitter coil 811 via receiver coil 801. The received power is rectified by rectifier 1206 and used to power receiver 702.

Wireless charger 602 may operate as an inductive charger or as a resonant charger. When operating as an inductive charger, driver 1204 may drive transmitter coil 811 at frequencies between 80 kHz and 300 kHz inclusive, for example. Other frequencies may also be used. When operating as a resonant charger, driver 1204 may drive transmitter coil 811 at frequencies equal or higher than 1 MHz, such as 6.78 MHz, for example. Other frequencies may also be used. In some embodiments, wireless charger may operate in accordance to the Qi standard.

Rectifier 1202 may be implemented in any way known in the art. For example, in some embodiments, rectifier 1202 may be implemented by a diode bridge. A synchronous rectifier may also be used.

In some embodiments, a switched-mode power supply (SMPS) AC/DC converter (not shown) may be used to convert AC power to DC power instead of rectifier 1202. In such embodiments, the AC/DC converter may include a transformer that galvanically isolates wireless charger 602 from mains power, and may be implemented in any way known in the art, such as using a flyback or LLC converter, for example. In some embodiments implementing the AC/DC converter, the AC/DC converter may be configured to operate with 120 V_{RMS}, 60 Hz mains as well as with 230 V_{RMS}, 50 Hz mains.

Driver 1204 is configured to drive transmitter coil 811 at frequencies, such as between 80 kHz and 300 kHz. Other frequencies may also be used. Driver 1204 may be implemented in any way known in the art, such as by using a half-bridge or a full-bridge, for example. In some embodiments, driver 1204 is coupled to mains power via passive devices only (e.g., via a diode bridge), avoiding the use of an SMPS and a dedicated transformer. In such embodiments, driver 1204 operates from a voltage rail that is derived from mains and that is relatively high voltage. For example, in embodiments in which mains power is a 120 V_{RMS}, 60 Hz, the voltage rail provided by rectifier 1202 to driver 1204 may reach 150 V.

Rectifier 1206 may be implemented in any way known in the art, such as by using a diode bridge or a synchronous rectifier, for example.

Advantages of some embodiments include that a mains power fixture provides wireless power with a form factor that is compatible with conventional power outlets. Some embodiments are advantageously galvanically isolated from mains without using an AC/DC converter and without using a dedicated transformer.

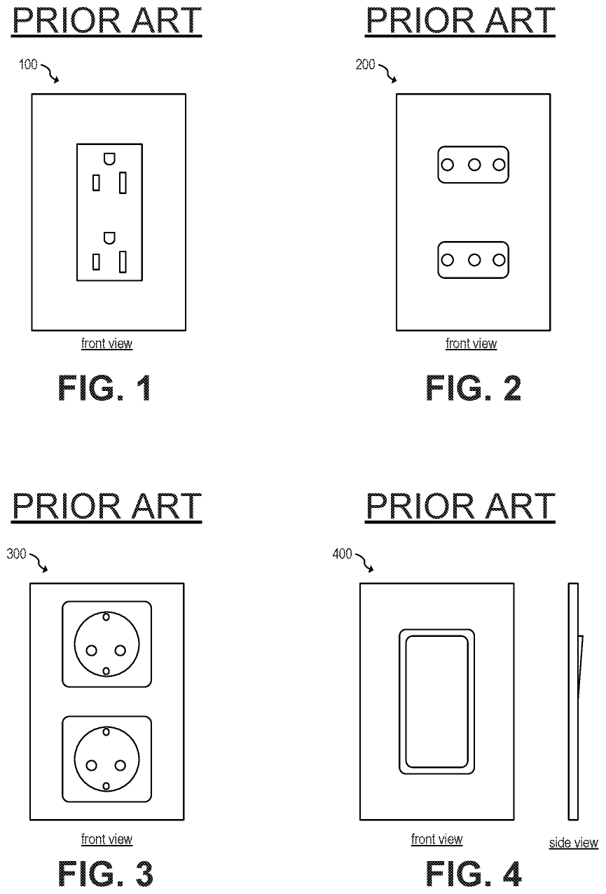

Additional advantages of some embodiments include that a mains power fixture may be used in countries that use different mains power standards (e.g., 120 V_{RMS}, 60 Hz, and 230 V_{RMS}, 50 Hz) and/or different electric power outlet standards (e.g., see FIGS. 1-3) without modification.

In some embodiments, mains power fixture 600 may also be used as a switch to control a light bulb or other equipment. For example, FIG. 13 shows schematic diagram 1300 of mains power fixture 600 including switch functionality, according to an embodiment of the present invention.

During normal operation, controller 1304 turns on switch 1302 to cause AC power to be delivered to load 1306 and turns off switch 1302 to prevent AC power to be delivered to load 1306.

In some embodiments, controller 1304 turns on and off switch 1302 based on an external signal. For example, in some embodiments, an accelerometer (not shown) is attached to cover 504. Controller 1306 is configured to detect taps in cover 504 based on an output of the accelerometer and is configured to control switch 1302 based on whether a tap has been detected and/or on the number of taps detected. For example, in some embodiments, controller turns on switch 1302 when controller 1304 detects 1 tap, and turns off switch 1302 when controller 1304 detects 2 taps. Other implementations are also possible. In some embodiments, dimmer functionality may also be implemented. For example, in some embodiments, the number of taps may indicate the intensity of light desired (e.g., the more taps within a time frame, the more intensity of light).

In some embodiments, the external signal is received from a wireless communication interface, such as a WiFi device, for example. Other implementations are also possible.

Switch 1302 may be implemented in any way known in the art. For example, in some embodiments, switch 1302 is implemented as a mechanical relay. Switch 1302 may be implemented with solid state relays, triacs, transistors, or in any other way.

Controller 1304 may be implemented in any way known in the art. For example, some embodiments may implement controller 1304 with a general purpose controller. Other embodiments may implement controller 1304 using a digital signal processor (DSP) or a field programmable gate array (FPGA). Yet other embodiments may implement controller 1304 using custom logic, such as an application-specific integrated circuit (ASIC). Other implementations are also possible.

Load 1306 may be a light, garbage disposal, or other device, for example.

Some embodiments are advantageously capable of providing power to a device while also performing the functions of a switch to control a load. A conventional light switch, thus, can advantageously be replaced with a mains power fixture, such as mains power fixture 600, to provide wireless power to a device while still performing the functions of a light switch. It is understood that the term light switch is not limited to controlling a light, but can also be extended to control other devices, such as permanently connected equipment.

Example embodiments of the present invention are summarized here. Other embodiments can also be understood from the entirety of the specification and the claims filed herein.

Example 1. A mains power fixture including: mains input terminals or wires configured to be coupled to mains power supply; a wireless charging area; a cover at least partially surrounding the wireless charging area; a rectifier coupled to the mains input terminals; and a wireless charger directly electrically connected to the rectifier, the wireless charger including: a ferrite core in proximity to the wireless charging area, a transmitter coil wrapping around the ferrite core, and a driver configured to receive a rectified voltage from the rectifier and to drive the transmitter coil at a switching frequency.

Example 2. The mains power fixture of example 1, where the ferrite core includes a base, a first leg having a first end in contact with a first portion of the base, and a second leg having a first end in contact with a second portion of the base, the first portion of the base located at a distance greater than 0 mm from the second portion of the base, the first leg having a second end in contact with the wireless charging area, the second leg having a second end in contact with the wireless charging area, the first leg being separated from the second leg by air, and where the transmitter coil includes a first winding wrapping around the first leg and a second winding wrapping around the second leg.

Example 3. The mains power fixture of one of examples 1 or 2, where the ferrite core has a U shape, and where each end of the U shaped ferrite core is in proximity to the wireless charging area.

Example 4. The mains power fixture of one of examples 1 to 3, where the U shaped ferrite core includes a depth of about 12 mm, a width of about 25 mm, and a height of about 20 mm.

Example 5. The mains power fixture of one of examples 1 to 4, where the first leg includes a first ferrite rod and the second leg includes a second ferrite rod.

Example 6. The mains power fixture of one of examples 1 to 5, where the base, the first leg, and the second leg are formed as a single and uniform ferrite core.

Example 7. The mains power fixture of one of examples 1 to 6, where the switching frequency is between 80 kHz and 300 kHz, inclusive.

Example 8. The mains power fixture of one of examples 1 to 7, where the switching frequency is 6.78 MHz.

Example 9. The mains power fixture of one of examples 1 to 8, where the cover includes a magnet.

Example 10. The mains power fixture of one of examples 1 to 9, where the wireless charging area includes a magnet.

Example 11. The mains power fixture of one of examples 1 to 10, further including a magnet disposed on a surface of the wireless charging area.

Example 12. The mains power fixture of one of examples 1 to 11, further including: a switch coupled to a first input terminal of the mains input terminals, the switch configured to be coupled to a load; and a controller configured to control the switch to turn on and off the load.

Example 13. The mains power fixture of one of examples 1 to 12, where the controller is configured to control the switch while the driver is driving the transmitter coil at the switching frequency.

Example 14. The mains power fixture of one of examples 1 to 13, where the ferrite core being in proximity to the wireless charging area includes the ferrite core being in contact with the wireless charging area.

Example 15. A light switch including: mains input terminals configured to be coupled to mains power supply; a wireless charging area; a cover at least partially surrounding the wireless charging area; a rectifier coupled to the mains input terminals; a wireless charger coupled to the rectifier, the wireless charger including: a ferrite core in contact with the wireless charging area, a transmitter coil wrapping around the ferrite core, and a driver configured to receive a rectified voltage from the rectifier and to drive the transmitter coil at a switching frequency; a switch coupled to a first input terminal of the mains input terminals, the switch configured to be coupled to a load; and a controller configured to control the switch to turn on and off the load.

Example 17. The light switch of one of examples 15 or 16, where the switch includes a relay.

Example 18. The light switch of one of examples 15 to 17, where the controller is configured to: detect taps in the cover or the wireless charging area; and control the switch based on the detected taps.

Example 19. A method including: receiving mains power with mains input terminals; rectifying the mains power with a diode bridge to provide a rectified voltage; and driving a transmitter coil at a switching frequency with a driver that receives the rectified voltage to transmit wireless power through a wireless charging area, the transmitter coil being wrapped around a ferrite core that is in contact with the wireless charging area.

Example 20. The method of example 19, further including controlling a switch coupled between the mains input terminals and a load.

Example 21. The method of one of examples 19 or 20, further including detecting taps, where controlling the switch includes controlling the switch based on the detected taps.

Example 22. The method of one of examples 19 to 21, where the load includes a light bulb.

Example 23. The method of one of examples 19 to 22, further including receiving the wireless power by a receiver that is in contact with the wireless charging area, the receiver being galvanically isolated from mains power.

Example 24. The method of one of examples 19 to 23, where the ferrite core has a U shape, each leg of the U shaped ferrite core being separated by a first distance, the receiver including a receiver coil having a first winding and a second winding, the first winding of the receiver coil being separated from the second winding of the receiver coil by about the first distance.

Example 25. The method of one of examples 19 to 24, where the mains input terminals, the diode bridge, the transmitter coil and the ferrite core are disposed inside a wall, and the receiver is outside the wall.

Example 26. The method of one of examples 19 to 25, where the rectified voltage is higher than no V.

Example 27. The method of one of examples 19 to 26, where the switching frequency is between 80 kHz and 300 kHz inclusive.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description.

What is claimed is:

1. A mains power fixture comprising:
mains input terminals or wires configured to be coupled to mains power supply;
a wireless charging area;
a rectifier coupled to the mains input terminals; and
a wireless charger directly electrically connected to the rectifier, the wireless charger comprising:
a ferrite core in proximity to the wireless charging area,
a transmitter coil wrapping around the ferrite core, and
a driver configured to receive a rectified voltage from the rectifier and to drive the transmitter coil at a switching frequency.

2. The mains power fixture of claim 1, wherein the ferrite core comprises a base, a first leg having a first end in contact with a first portion of the base, and a second leg having a first end in contact with a second portion of the base, the first portion of the base located at a distance greater than 0 mm from the second portion of the base, the first leg having a second end in contact with the wireless charging area, the second leg having a second end in contact with the wireless charging area, the first leg being separated from the second leg by air, and wherein the transmitter coil comprises a first winding wrapping around the first leg and a second winding wrapping around the second leg.

3. The mains power fixture of claim 2, wherein the ferrite core has a U shape, and wherein each end of the U shaped ferrite core is in proximity to the wireless charging area.

4. The mains power fixture of claim 3, wherein the U shaped ferrite core comprises a depth of about 12 mm, a width of about 25 mm, and a height of about 20 mm.

5. The mains power fixture of claim 2, wherein the first leg comprises a first ferrite rod and the second leg comprises a second ferrite rod.

6. The mains power fixture of claim 2, wherein the base, the first leg, and the second leg are formed as a single and uniform ferrite core.

7. The mains power fixture of claim 1, wherein the switching frequency is between 80 kHz and 300 kHz, inclusive.

8. The mains power fixture of claim 1, wherein the switching frequency is 6.78 MHz.

9. The mains power fixture of claim 1, further comprising a cover at least partially surrounding the wireless charging area.

10. The mains power fixture of claim 9, wherein the cover comprises a magnet.

11. The mains power fixture of claim 1, wherein the wireless charging area comprises a magnet.

12. The mains power fixture of claim 1, further comprising a magnet disposed on a surface of the wireless charging area.

13. The mains power fixture of claim 1, further comprising:
a switch coupled to a first input terminal of the mains input terminals, the switch configured to be coupled to a load; and
a controller configured to control the switch to turn on and off the load.

14. The mains power fixture of claim 13, wherein the controller is configured to control the switch while the driver is driving the transmitter coil at the switching frequency.

15. The mains power fixture of claim 1, wherein the ferrite core being in proximity to the wireless charging area comprises the ferrite core being in contact with the wireless charging area.

16. A light switch comprising:
mains input terminals configured to be coupled to mains power supply;
a wireless charging area;
a rectifier coupled to the mains input terminals;
a wireless charger coupled to the rectifier, the wireless charger comprising:
a ferrite core in contact with the wireless charging area,
a transmitter coil wrapping around the ferrite core, and
a driver configured to receive a rectified voltage from the rectifier and to drive the transmitter coil at a switching frequency;
a switch coupled to a first input terminal of the mains input terminals, the switch configured to be coupled to a load; and
a controller configured to control the switch to turn on and off the load.

17. The light switch of claim 16, further comprising a magnet disposed on a surface of the wireless charging area.

18. The light switch of claim 16, wherein the switch comprises a relay.

19. The light switch of claim 16, further comprising a cover at least partially surrounding the wireless charging area, wherein the controller is configured to:
detect taps in the cover or the wireless charging area; and
control the switch based on the detected taps.

20. A method comprising:
receiving mains power with mains input terminals;
rectifying the mains power with a diode bridge to provide a rectified voltage; and
driving a transmitter coil at a switching frequency with a driver that receives the rectified voltage to transmit wireless power through a wireless charging area, the transmitter coil being wrapped around a ferrite core that is in contact with the wireless charging area.

21. The method of claim 20, further comprising controlling a switch coupled between the mains input terminals and a load.

22. The method of claim 21, further comprising detecting taps, wherein controlling the switch comprises controlling the switch based on the detected taps.

23. The method of claim 21, wherein the load comprises a light bulb.

24. The method of claim 20, further comprising receiving the wireless power by a receiver that is in contact with the wireless charging area, the receiver being galvanically isolated from mains power.

25. The method of claim 24, wherein the ferrite core has a U shape, each leg of the U shaped ferrite core being separated by a first distance, the receiver comprising a receiver coil having a first winding and a second winding, the first winding of the receiver coil being separated from the second winding of the receiver coil by about the first distance.

26. The method of claim 24, wherein the mains input terminals, the diode bridge, the transmitter coil and the ferrite core are disposed inside a wall, and the receiver is outside the wall.

27. The method of claim 20, wherein the rectified voltage is higher than no V.

28. The method of claim 20, wherein the switching frequency is between 80 kHz and 300 kHz inclusive.
